(19) United States
(12) Patent Application Publication
(10) Pub. No.: US 2017/0080656 A1
(43) Pub. Date: Mar. 23, 2017

(54) Mould Element For A Tire Mould Comprising A Mark

(71) Applicants: COMPAGNIE GENERALE DES ETABLISSEMENTS MICHELIN, Clermont-Ferrand (FR); Michelin Recherche et Technique S.A., Granges-Paccot (CH)

(72) Inventors: Olivier MUHLHOFF, Clermont-Ferrand Cedex 9 (FR); Jean-Claude DESVIGNES, Clermont-Ferrand Cedex 9 (FR)

(21) Appl. No.: 15/307,996

(22) PCT Filed: Apr. 28, 2015
(86) PCT No.: PCT/EP2015/059121

§ 371 Date: Oct. 31, 2016

(30) Foreign Application Priority Data
Apr. 30, 2014 (FR) 1453986

(51) Int. Cl. B29D 30/06

(52) U.S. Cl. CPC B29D 30/0606; B29D 2030/0616; B29D 2030/726

(57) ABSTRACT

A mould element (2) for a mould for a tire comprising a marking (20), the mould comprising a shell intended to mould the sidewall (10) of the tire (1). The mould element (2) is a removable insert intended to be mounted in a housing of the shell, and the marking (20) is intended to mould on the tire a coded matrix symbol that contrasts with the sidewall of the tire, the marking (20) comprising a first set of cavities (201) or of protuberances (202) which is designed to mould dark parts of the coded matrix symbol (5).

### FIELD OF THE INVENTION

The present invention relates to a mould element for a mould for a tire comprising a marking, the said mould comprising a shell intended to mould the sidewall of the tire.

It also relates to a mould for a tire in which the said mould element is mounted.

It finally relates to a method of manufacturing the said mould element for a tire mould.

### PRIOR ART

The use of a coded matrix symbol on the sidewall of a tire is known from document EP1636117, the said coded matrix symbol containing information such as an individual serial number for the said tire, the website of the tire manufacturer, etc. A coded matrix symbol comprises dark parts and light parts and is etched directly onto the sidewall of the tire after the latter has gone through all the manufacturing phases and all the conformity testing. After manufacture, each tire is placed on a dedicated line for the manufacture of coded matrix symbols which carries out various steps including, in particular, the positioning of the tire on the manufacturing line, the reading of a position reference on the tire, the aligning of the tire with a laser according to the position reference, the marking by laser etching of the coded matrix symbol.

One disadvantage with this prior art lies in the fact that the dedicated laser-etching manufacturing line is complicated to implement and also expensive. Moreover, as the tire becomes worn, the coded matrix symbol becomes less legible.

There is now a need to improve the legibility of the coded matrix symbols present on the sidewalls of tires so as to make them easier to read while at the same time making the manufacture of the marking of the said coded matrix symbols perform better.

### DEFINITIONS

A “tire” means any type of resilient band whether or not subjected to an internal pressure.

A “rubbery material” means a diene elastomer, namely in the known way an elastomer derived at least in part (namely a homopolymer or a copolymer) from diene monomers (monomers bearing two conjugated or non-conjugated carbon-carbon double bonds).

A “coded matrix symbol” means a so-called “smart” code in which data are encoded in two dimensions (in the form of a plurality of rows and columns), the data being decodeable by an imager of a machine, such as a mobile telephone. A coded matrix symbol encodes a distinctly greater volume of data for the same given surface area than a traditional linear bar code and has an inbuilt error correction system.

The “tread” of a tire means of a quantity of rubbery material delimited by lateral surfaces and by two main surfaces of which one, called the running surface, is intended to come into contact with a roadway when the tire is running

The “sidewall” of a tire means a lateral surface of the tire positioned between the tread of the tire and a bead of this tire.

A “texture” means an organised arrangement of a plurality of elements, all or some of the elements of the arrangement being a repeat of the one same basic element, for example a strand or a lamella.

A “strand” means a filiform element of which the height is at least equal to twice the diameter of a disc having the same surface area as a mean cross section of the strand.

“Lamellae” mean elongate strands that have a length at least equal to twice their height.

A “texture formed as an integral part of a sidewall” means that the texture is made from the same rubbery material as the sidewall of the tire. This then produces a texture without the addition of another material.

### SUMMARY OF THE INVENTION

The invention relates to a mould element for a mould for a tire comprising a marking, the said mould comprising a shell intended to mould the sidewall of the tire. The said mould element is a removable insert intended to be mounted in a housing of the said shell, and the said marking is intended to mould on the said tire a coded matrix symbol that contrasts with the sidewall of the tire, the said marking comprising a first set of cavities or of protuberances which is designed to mould dark parts of the coded matrix symbol.

Thus, the creation of the marking on a mould element will make it possible to produce a coded matrix symbol on the sidewall of the tire at the time of manufacture of the said tire. There is no longer any need to have a dedicated manufacturing line. Moreover, the marking allows the creation of a coded matrix symbol comprising the dark parts of the coded matrix symbol in strong contrast with the rest of the sidewall of the tire and also with the light parts of the said symbol. The coded matrix symbol thus becomes easier to read.

According to some nonlimiting embodiments, the tire may further comprise one or more of the following additional features.

In one nonlimiting embodiment, the marking comprises a second set of protuberances projecting from the said mould element and designed to mould light parts of the coded matrix symbol and the said protuberances have the shape of caps of a sphere, each protruding element being interpenetrated by several adjacent protruding elements.

That makes it possible to create elements that are set back from the surface of the sidewall.

In one nonlimiting embodiment, the marking comprises a set of set-back recesses designed to mould light parts of the coded matrix symbol and the said set-back recesses have the shape of caps of a sphere.

That makes it possible to create boss elements protruding from the surface of the sidewall.

In one nonlimiting embodiment, the said mould element comprises a second set of cavities which is designed to mould a demarcation zone delineating the coded matrix symbol.

That makes it possible to create a textured zone formed as an integral part of the sidewall and contrasting with the rest of the tire.

In one nonlimiting embodiment, the cavities of the first set of cavities have a conical shape and are distributed through the marking at a density at least equal to one cone per square millimetre (mm²), each cone having a mean cross section comprised between 0.0005 mm² and 1 mm².

That makes it possible to create elements protruding from the surface of the sidewall and that take the form of a strand.

In one nonlimiting embodiment, the cavities of the first set of cavities have a form of substantially mutually parallel striations, the spacing of the striations being at most equal to 0.5 mm, each striation having a mean width comprised between 0.02 mm and 0.25 mm.

That makes it possible to create elements protruding from the surface of the sidewall and that take the form of a lamella.

In one nonlimiting embodiment, the cavities of the first set of cavities have a parallelepiped shape of side length comprised between 0.05 mm and 0.5 mm, of depth comprised between 0.05 mm and 0.5 mm, the distance between two adjacent cavities in the marking being comprised between 0.05 mm and 0.5 mm.

That makes it possible to create protruding elements that take the form of a parallelepiped.

In one nonlimiting embodiment, the protuberances of the first set of protuberances have a conical shape and are distributed through the marking at a density at least equal to one protuberance per square millimetre (mm²), these protuberances having equivalent diameters comprised between 0.01 mm and 1.2 mm.

That makes it possible to create elements that are set back from the surface of the sidewall.

Also proposed is a mould for a tire comprising a shell intended to mould the sidewall of the tire, the said shell comprising a housing in which is mounted a mould element according to any one of the preceding features.

Also proposed is a method of manufacturing a mould element for a mould for a tire, the said mould comprising a shell intended to mould the sidewall of the tire, the said mould element being a removable insert intended to be mounted in a housing of the said shell and comprising a marking, the said method comprising:
extraction of the said mould element from a sheet of aluminium;
creation of the marking intended to mould, on the tire, a coded matrix symbol that contrasts with the sidewall of the tire, the said coded matrix symbol comprising dark parts and light parts, the creation of the said marking comprising:
   the creation of the marking suited to moulding the light parts of the coded matrix symbol in the said mould element; and
   the creation of the marking suited to moulding the dark parts of the coded matrix symbol in the said mould element.

In one nonlimiting embodiment, the steps of creating the marking suited to moulding the light parts and the dark parts of the coded matrix symbol in the said mould element are performed simultaneously by pressing the said mould element.

In one nonlimiting embodiment, the creation of the marking suited to moulding the light parts of the coded matrix symbol in the said mould element is performed before the extraction of the said mould element from the sheet of aluminium.

In one nonlimiting embodiment, the creation of the marking suited to moulding the light parts of the coded matrix symbol is carried out:
by a surface treatment of the said mould element so that the surface of the said mould element corresponds to the said light parts; or
by micro shot peening of a second set of protuberances projecting from the said mould element to form the marking of the coded matrix symbol so that the said protuberances have the shape of caps of a sphere, each protruding element being interpenetrated in the marking by several adjacent protruding elements, the second set of protuberances being suited to moulding the said light parts of the coded matrix symbol; or
by moulding of a set-back set of recesses having the shape of caps of a sphere, the said set of recesses being suited to moulding the said light parts of the coded matrix symbol.

In one nonlimiting embodiment, the micro shot peening creates microbeads of a diameter comprised between 10 μm and 200 μm.

In one nonlimiting embodiment, the creation of the marking suited to moulding the dark parts of the coded matrix symbol in the said mould element is performed by creating a first set of cavities or of protuberances in the said mould element suited to moulding the said dark parts of the coded matrix symbol, the creation of the first set of cavities in the said mould element being carried out by laser etching and the creation of the first set of protuberances in the said mould element being performed by moulding.

### BRIEF DESCRIPTION OF THE DRAWINGS

Further features and advantages of the invention will emerge from the following description, given by way of nonlimiting example, with reference to the attached drawings in which:

FIG. 1 is a schematic radial cross section of a mould comprising a mould element according to the invention according to one nonlimiting embodiment;

FIG. 2 is a schematic perspective view of the mould element of FIG. 1 comprising a marking corresponding to the negative of a coded matrix symbol according to one nonlimiting embodiment;

FIG. 3 is a schematic perspective view of part of a tire comprising a sidewall in which is arranged a coded matrix symbol produced by means of the mould element of FIG. 2;

FIG. 4 depicts a coded matrix symbol for the sidewall of FIG. 3 according to one nonlimiting embodiment, the coded matrix symbol comprising dark parts and light parts, the dark parts being made up of a particular texture;

FIG. 5 depicts the coded matrix symbol of the sidewall of FIG. 4 surrounded by a demarcation zone;

FIG. 6 is a cross section of part of the mould element of FIG. 1 for moulding the dark parts of a coded matrix symbol according to a first nonlimiting embodiment;

FIG. 7 is a cross section of part of the mould element of FIG. 1 for moulding the dark parts of a coded matrix symbol according to a second nonlimiting embodiment;

FIG. 8 depicts part of the texture that makes up the dark parts of a coded matrix symbol obtained by the mould element of FIG. 6;

FIG. 9 depicts part of the texture that makes up the dark parts of the coded matrix symbol obtained by the mould element of FIG. 6;

FIG. 10 is a cross section of part of the mould element of FIG. 1 for moulding the dark parts of a coded matrix symbol according to a third nonlimiting embodiment;

FIG. 11 depicts part of the texture that makes up the dark parts of the coded matrix symbol obtained by the mould element of FIG. 10;

FIG. 12 is a cross section of part of the mould element of FIG. 1 for moulding the dark parts of a coded matrix symbol according to a fourth nonlimiting embodiment;

FIG. 13 depicts part of the texture that makes up the dark parts of the coded matrix symbol obtained by the mould element of FIG. 12;

FIG. 14 is a cross section of part of the mould element of FIG. 1 for moulding the light parts of a coded matrix symbol according to a first nonlimiting embodiment;

FIG. 15 is a perspective view of a plurality of recessed elements of a pattern making up the light parts of the coded matrix symbol obtained by the mould element of FIG. 14;

FIG. 16 is a cross section of part of the mould element of FIG. 1 for moulding the light parts of a coded matrix symbol according to a second nonlimiting embodiment;

FIG. 17 is a perspective view of a plurality of recessed elements of a pattern that makes up the light parts of the coded matrix symbol obtained by the mould element of FIG. 16; and

FIG. 18 is a flow diagram of a method of manufacturing a mould element of FIGS. 6, 7, 10, 12, 14, 16 according to one nonlimiting embodiment.

In the description which will follow, elements that are substantially identical or similar will be denoted by identical references.

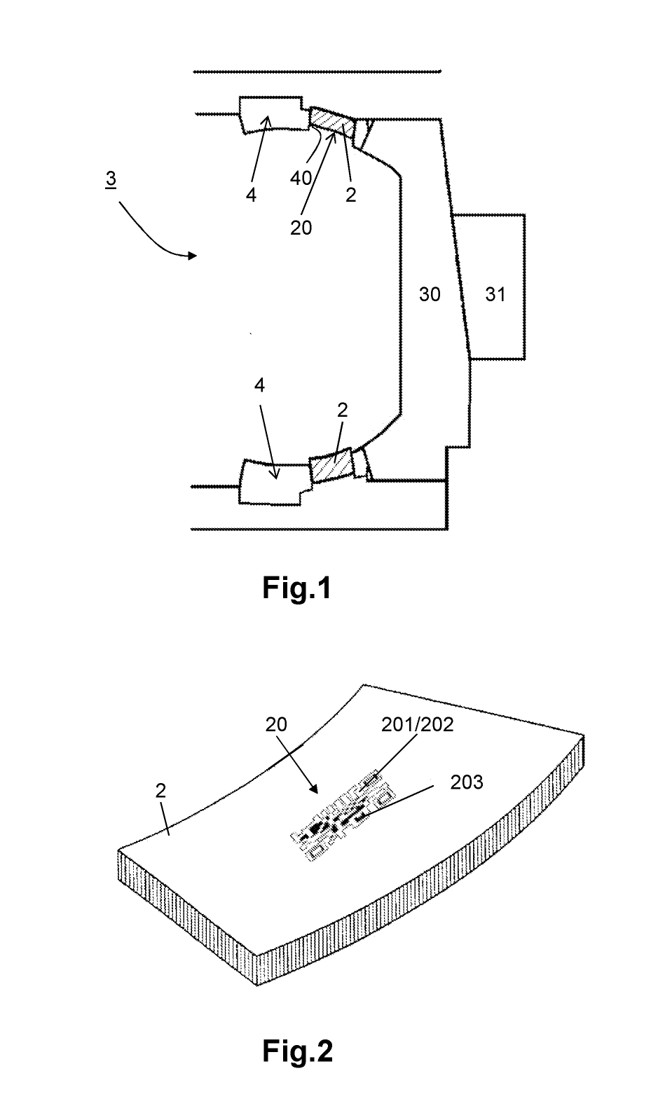

FIG. 1 illustrates a mould 3 comprising:
a shell 4 intended to mould the sidewall 10 of a tire 1, the said shell comprising a housing 40 in which a mould element 2 is mounted;
a segment 30 held closed by a conically tapering band 31;
a mould element 2 comprising a marking 20.

The mould element 2 is a removable insert intended to be mounted in the housing 40 of the shell 4. In one nonlimiting embodiment, the said insert 2 is made of aluminium. That makes it possible to have a removable insert that is ductile and that therefore makes it easier to create the marking in the insert 2. The marking 20 is intended to mould on the tire a coded matrix symbol 5 that contrasts with the sidewall of the tire. The marking 20 therefore corresponds to the negative of the coded matrix symbol 5 that is to be inscribed on the tire.

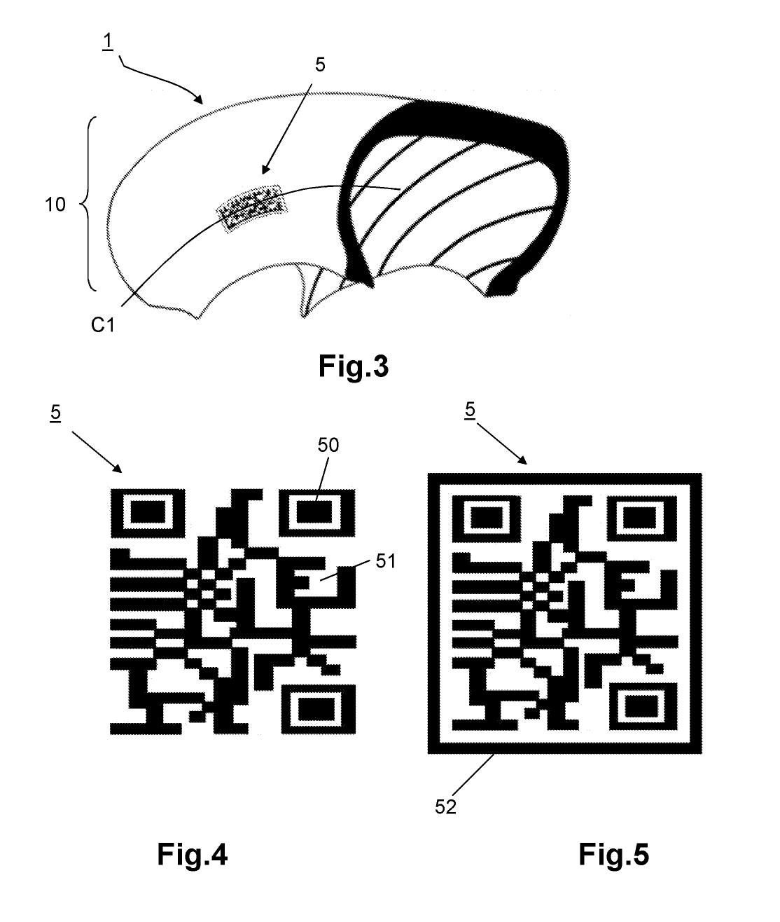

FIG. 2 illustrates a nonlimiting example of a mould element 2 comprising such a marking 20. It will be noted that the removable insert 2 is slightly curved so as to conform to the shape of the mould 3. Accordingly, the coded matrix symbol 5 resulting therefrom will follow the curvature C1 of the sidewall of the tire 1, the said curvature C1 (illustrated in FIG. 3) being defined along a parallel with respect to the axis of rotation of the tire. In other words, the coded matrix symbol 5 will be curved about the axis of rotation of the tire 1. That will give the tire a more attractive appearance because the coded matrix symbol 5 will appear to form an integral part of the sidewall 10. Moreover, in one nonlimiting embodiment, the marking 20 is rectangular and oriented in the direction of the insert 2 as illustrated in FIG. 2. The resulting coded matrix symbol 5 will thus be of rectangular shape.

As illustrated in FIG. 2, the marking 20 comprises a first set of cavities 201 or of protuberances 202 suited to moulding the dark parts 50 of the coded matrix symbol 5. Moreover, the marking 20 comprises a second set of protuberances 203 protruding from the said insert 2 and suited to moulding to light parts 51 of the coded matrix symbol 5.

FIG. 3 illustrates the sidewall 10 of a tire 1, the said sidewall 10 comprising a coded matrix symbol 5 obtained using the marking 20 of the mould element 2.

It will be noted that, in nonlimiting embodiments, the coded matrix symbol 5 is selected from the following symbols:

a datamatrix™;

a QR™;

a QR code™;

a MaxiCode™;

a PDF-417™;

a code 16K™;

a code 49™;

an Aztec™ code, or any other coded matrix symbol.

It will be recalled that a coded matrix symbol 5 makes it possible to encode information such as the manufacturer's mark, the manufacturer's website, etc. Using reading/decoding means such as an imager built, in a nonlimiting example, into a mobile telephone, anybody looking at the tire will be able to read and decode the coded matrix symbol 5 and access the manufacturer's website, for example in order to order a new tire.

FIG. 4 depicts a first nonlimiting embodiment of the coded matrix symbol 5. As can be seen in the figure, the coded matrix symbol 5 comprises dark parts 50 and light parts 51. As is known to those skilled in the art, in one nonlimiting embodiment, the dark parts 50 and light parts 51 are dark boxes and light boxes respectively, one part corresponding to one box. The coded matrix symbol 5 thus comprises columns and rows of boxes (or squares). In one nonlimiting embodiment, a box has a size comprised between 0.5×0.5 mm to 2×2 mm. Outside of that range the coded matrix symbol 5 becomes too intrusive or is far too miniaturized and therefore too fragile to be decoded at the end of the wearing life of the tire 1. In a nonlimiting alternative form of embodiment, a box has a size of 1×1 mm In another nonlimiting embodiment, the dark parts 50 and light parts 51 are dark circles and, respectively, light circles. In another nonlimiting embodiment, it is possible to have a combination of boxes and circles.

The dark parts 50 are made up of a texture formed as an integral part of the said sidewall 10. The texture contrasts with the rest of the tire 1 and notably the rest of the sidewall 10 of the tire 1 so that the coded matrix symbol 5 is clearly visible on the sidewall 10 to somebody looking at the tire.

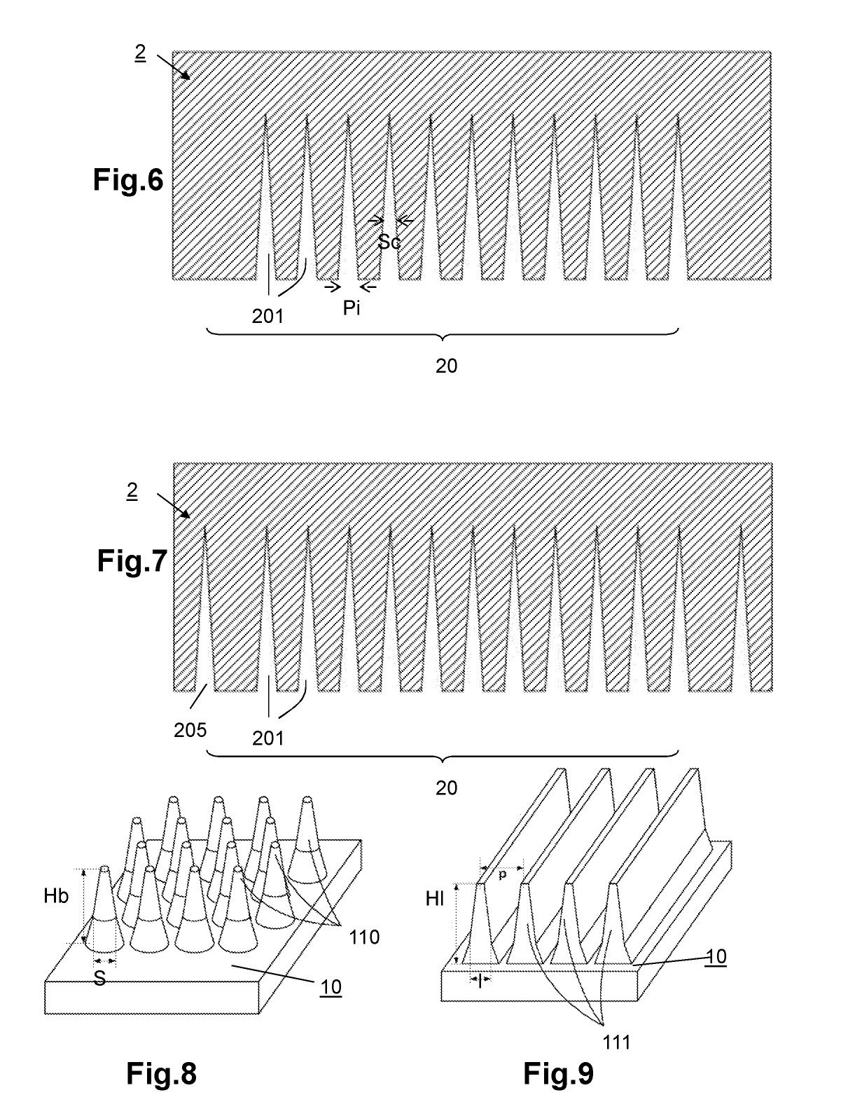

FIG. 5 depicts a second nonlimiting embodiment of the coded matrix symbol 5. As can be seen in the figure, aside from the dark parts 50 and the light parts 51, the coded matrix symbol 5 is surrounded by a textured zone (or demarcation zone) 52 formed as an integral part of the sidewall and contrasting with the rest of the tire 1. In one nonlimiting embodiment, this zone 52 has a width Ld of at least 2 mm. This demarcation zone 52 does not touch the dark zones 50 of the coded matrix symbol 4. It is made up of the same texture of “velour” type (described later on in the description) as the dark parts 50, so that the amount of dark surface area in the image capture zone around the coded matrix symbol 5 is increased.

Thus, by increasing the amount of dark surface area in this way, the contrast between the light and dark regions of the matrix symbol 5 is increased in the processing carried out by the mobile telephone. This accordingly improves the reading/decoding of the symbol 5.

The dark parts 50, the light parts 51 and the demarcation zone 52 of the coded matrix symbol 5 are created using the mould element 2 according to nonlimiting embodiments set out in the remainder of the description.

The dark parts 50 of the coded matrix symbol 4 are created as follows.

As explained earlier, the marking 20 of the removable insert 2 comprises a first set of cavities 201 or of protuberances 202 suited to moulding the dark parts 50 of the coded matrix symbol 5.

The first set of cavities 201 has various shapes set out hereinabove, in order to create the dark parts 50 with various shapes.

The cavities 201 correspond to the negative of the dark parts 50. In other words, a plurality of cavities 201 corresponds to the negative of a dark box 50.

As illustrated in FIG. 6, in a first nonlimiting embodiment, the cavities of the first set of cavities 201 have a conical shape and are distributed through the marking 20 at a density at least equal to one cone per square millimetre mm², each cone 201 having a mean cross section Sc comprised between 0.0005 mm² and 1 mm²

That makes it possible to create a texture that forms the dark parts 50 which comprises a plurality of elements that protrude with respect to the surface of the sidewall 10 and which are in the form of strands 110 as illustrated in FIG. 8. In that figure, the strands 110 have a conical overall shape with a cross section that decreases along the height Hb of these strands. More specifically, the mean cross section of each strand, which corresponds to the mean of the cross sections S measured at regular intervals from the base of the strand, is comprised between 0.0005 mm² and 1 mm² Within the texture, the strands are distributed at a density at least equal to one strand per square millimetre.

As illustrated in FIG. 6 also, in a second nonlimiting embodiment, the cavities of the first set of cavities 201 have a form of substantially mutually parallel striations, the spacing Pi of the striations being at least equal to 0.05 mm and at most equal to 0.5 mm, each striation 201 having a mean width comprised between 0.02 mm and 0.25 mm.

That makes it possible to create a texture that forms the dark parts 50 which comprises a plurality of elements that protrude from the surface of the sidewall 10 which are in the form of lamellae 111 as illustrated in FIG. 9. In that figure, the lamellae 111 have a triangular overall cross section and the mean width of each lamella, corresponding to the mean of the widths 1 measured at regular intervals along the height H1 of the lamella, is comprised between 0.02 mm and 0.25 mm. Within the texture, the lamellae 111 are substantially mutually parallel and the spacing P of the lamellae is at least equal to 0.05 mm and at most equal to 0.5 mm.

In another embodiment, the cavities of the first set of cavities 201 exhibit a combination of cones and of striations so as to create a texture that forms the dark parts 50 which comprises a combination of strands 110 and of lamellae 111.

As illustrated in FIG. 7, in one nonlimiting embodiment, the mould element 2 comprises a second set of cavities 205 suited to moulding the demarcation zone 52 of the coded matrix symbol 5, which zone 52 is described hereinabove.

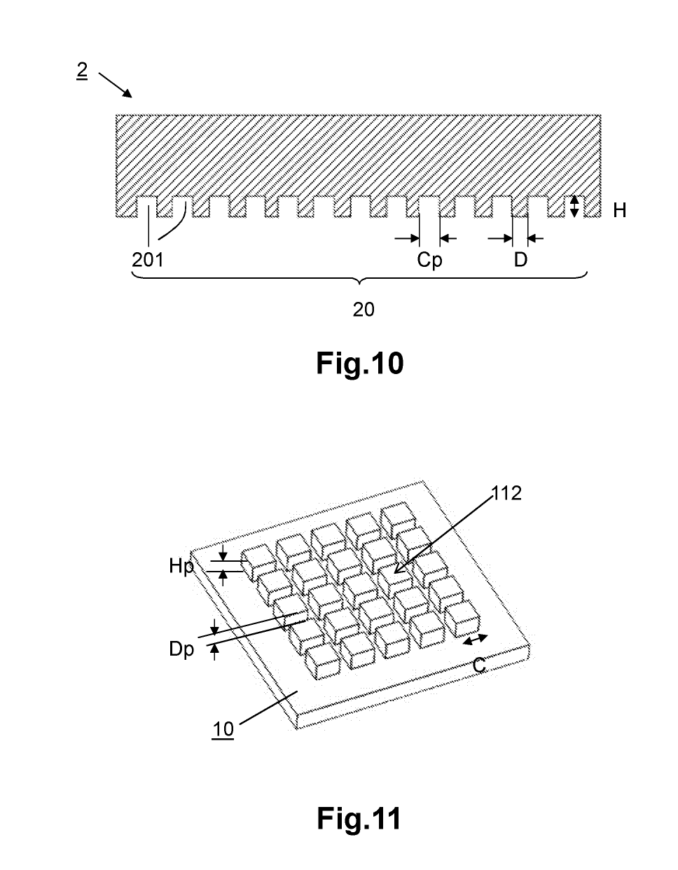

As illustrated in FIG. 10, in a third nonlimiting embodiment, the cavities of the first set of cavities 201 have the shape of parallelepipeds of side length Cp comprised between 0.05 mm and 0.5 mm, of depth H comprised between 0.05 mm and 0.5 mm, the distance D between two adjacent cavities in the marking 20 being comprised between 0.05 mm and 0.5 mm.

That makes it possible to create a texture that forms the dark parts 50 which comprises a plurality of elements that protrude from the surface of the sidewall 10 which are in the form of parallelepipeds 112 as illustrated in FIG. 11. In that figure, the parallelepipeds 112 have a side length C comprised between 0.05 mm and 0.5 mm, a height Hp comprised between 0.05 mm and 0.5 mm and a distance Dp between two adjacent parallelepipeds 112 in the texture comprised between 0.05 mm and 0.5 mm.

In another embodiment, the cavities of the first set of cavities 201 exhibit a combination of cones, striations and parallelepipeds, or of striations and parallelepipeds, or alternatively of cones and parallelepipeds as described hereinabove.

In a fourth nonlimiting embodiment which has not been illustrated, the cavities of the first set of cavities 201 have variable shapes and distances between cavities. That makes it possible to create protruding elements of varying shapes. That creates randomness in the texture that forms the dark parts 50, allowing these elements to be rendered less visible.

These protruding elements 110 to 112 form the texture formed as an integral part of the sidewall 10 and are therefore made of rubbery material. In other words, a dark box 50 contains a plurality of elements 110, 111 and/or 112.

The effect that the protruding elements 110 to 112 have is that of “trapping” a large quantity of the incident rays of light incident on the texture. The texture (referred to as “velour”) makes it possible to obtain a visual of “velour” type because the protruding elements absorb light and thus make the dark parts 51 of the coded matrix symbol 5 blacker. Anybody looking at the tire will be clearly able to distinguish these dark parts 50 from the light parts 51 and from the rest of the sidewall 10. Moreover, the texture is of “velour” type because it is pleasant to the touch.

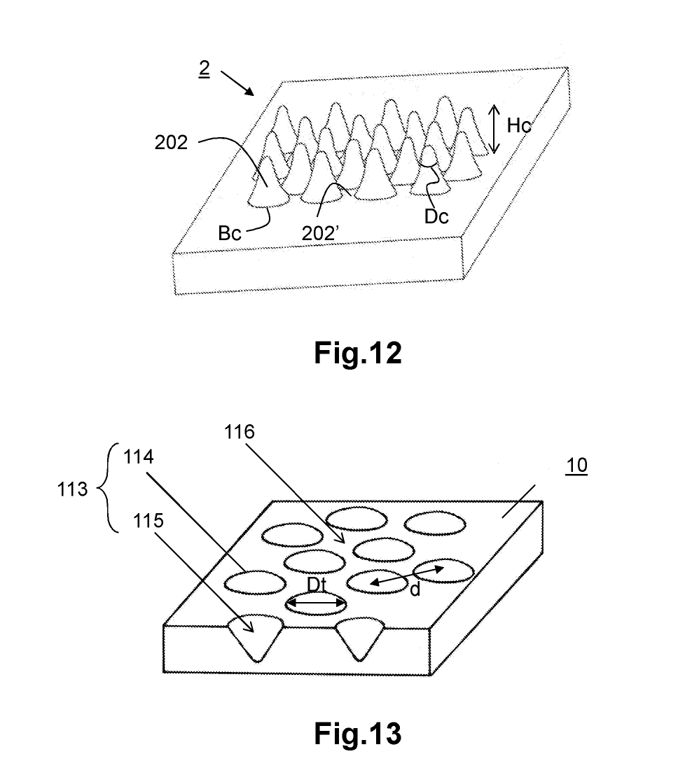

After the first set of cavities 201, the first set of protuberances 202 of the marking 20 is set out hereinbelow according to one nonlimiting embodiment as illustrated in FIG. 12. The marking 20 comprises a plurality of protuberances 202 protruding from the mould element 2 and intermediate parts 202′ separating the protuberances 202. The protuberances 202 have a conical shape and are distributed through the marking 20 at a density at least equal to one protuberance per square millimetre (mm²), these protuberances 202 having a base Bc of a circular overall shape and having an equivalent diameter Dc comprised between 0.01 mm and 1.2 mm. The protuberance density and/or the equivalent diameter Dc will be selected so that the protuberances 202 occupy a certain percentage of the marking 20. In one nonlimiting example, the protuberances 202 occupy at least 30% of the marking 20. According to other nonlimiting embodiments, the protuberances 202 occupy 50%, or even over 70%, of the marking 20.

Moreover, in one nonlimiting embodiment, the protuberances 202 have a height Hc at least equal to 0.1 mm. In one nonlimiting or alternative form of embodiment, the height Hc is comprised between 0.2 mm and 0.6 mm.

The protruding elements 202 correspond to the negative of the dark parts 50. In other words, a plurality of protruding elements 202 corresponds to the negative of a dark box 50.

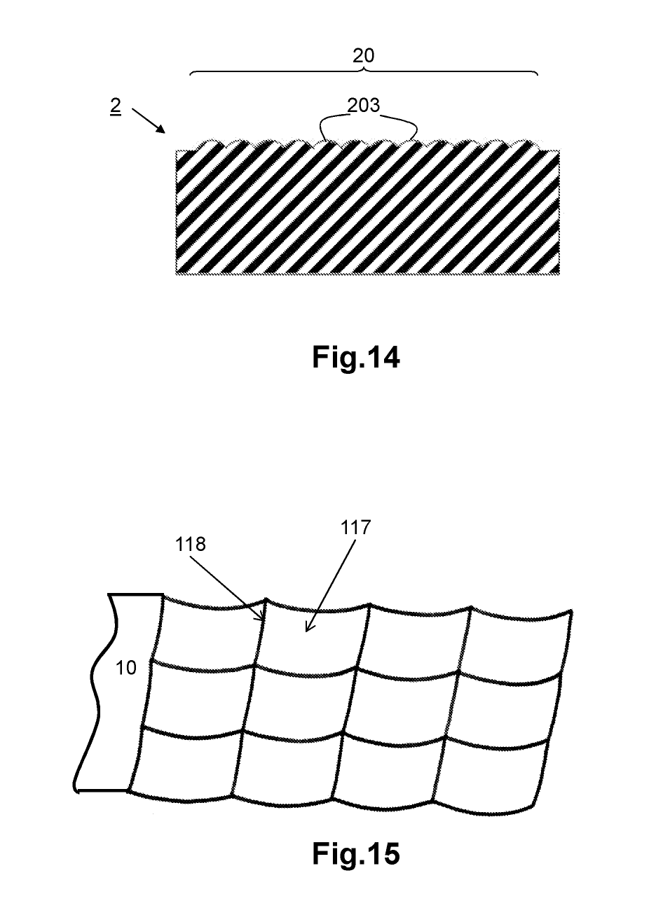

The protruding elements 202 make it possible to create a texture that forms the dark parts 50 which has first recessed elements 113 (also referred to as holes) as illustrated in FIG. 13.

The recessed elements 113 are made up of openings 114 on the surface of the sidewall 10 and of associated cavities 115 extending into the depth of the surface of the sidewall 10. The openings 114 continue into the depth of the surface of the sidewall 10 to form cavities 115.

The cavities 115 are in the form of cones and have a cross section that decreases into the depth of surface of the sidewall 10. In this way, the contrast between the texture, and therefore the coded matrix symbol 5, and the rest of the tire 1 and more particularly the rest of the sidewall 10 is improved. It will be noted that, in this alternative form, the openings 114 of the cavities 115 do not touch one another. The openings 114 are separated by intermediate zone 116. Furthermore, the openings 114 are evenly distributed through the texture such that the distance d between each opening in the texture is roughly the same. It will be noted that the greater the level of occupancy of the openings in the texture, the better the quality of contrast between this texture and, therefore, the dark parts 50 of the coded matrix symbol 4, and the light parts 51 and the rest of the sidewall 10.

The effect these cavities 115 have is that of “trapping” a large quantity of the incident rays of light incident upon the texture, and also of offering greater durability of the texture. Specifically, because the cavities 115 are recessed into the surface of the sidewall 10, the impact that mechanical attack on the texture, such as friction against a roadway, has is lower than in the case of protuberances. In this embodiment, the texture (referred to as “velour”) makes it possible to obtain a visual of “velour” type because the cavities absorb the light and thus make the dark parts 50 of the coded matrix symbol 5 appear blacker.

Having described the creation of the dark parts 50 of the coded matrix symbol 5, the remainder of the description describes the creation of the light parts 51 of the coded matrix symbol 5.

In a first nonlimiting embodiment, the mould element 2 in itself allows the light parts 51 to be created. Specifically, in this case, the light parts 51 are made up of a part of the surface of the sidewall 10 which has not been covered with the “velour” type texture described hereinabove, which part of the surface of the sidewall is delimited by the space occupied by the coded matrix symbol 5. Specifically, the surface of the sidewall 10 is smooth and reflects lights. Anybody looking at the tire will see a grey-white colour. Thus, the light parts 51 will be in contrast with respect to the dark parts 50 described hereinabove.

In a second nonlimiting embodiment illustrated in FIG. 14, the marking 20 comprises a second set of protuberances 203 projecting from the said mould element 2 and suited to moulding the light parts 51 of the coded matrix symbol 5 and the said protuberances 203 have the shape of caps of a sphere, each protruding element 203 being interpenetrated 20 by several adjacent protruding elements. Thus, these protuberances 203 correspond to the negative of the light parts 51. In other words, a plurality of protuberances 203 corresponds to the negative of a light box 51.

A “protruding element interpenetrated by other adjacent protruding elements” means that the cap of a sphere formed by the protruding element is interrupted by the other adjacent protruding elements so that the distance between the vertex of the cap of a sphere and the vertex of another adjacent protruding element is less than the diameter of this cap of a sphere.

The second protruding elements 203 make it possible to create a pattern that forms the light parts 51 which has recessed elements 117 as illustrated in FIG. 15. The second recessed elements 117 all have the same shape. The shape is an open surface. The shape is part of a sphere. In the nonlimiting embodiment illustrated, the second recessed elements 117 are aligned with respect to one another. That makes it possible clearly to delimit the light parts 51. Each second recessed element 117 is adjacent to another second recessed element 117. In addition, the second recessed elements 411 connect to one another at connecting zones 118.

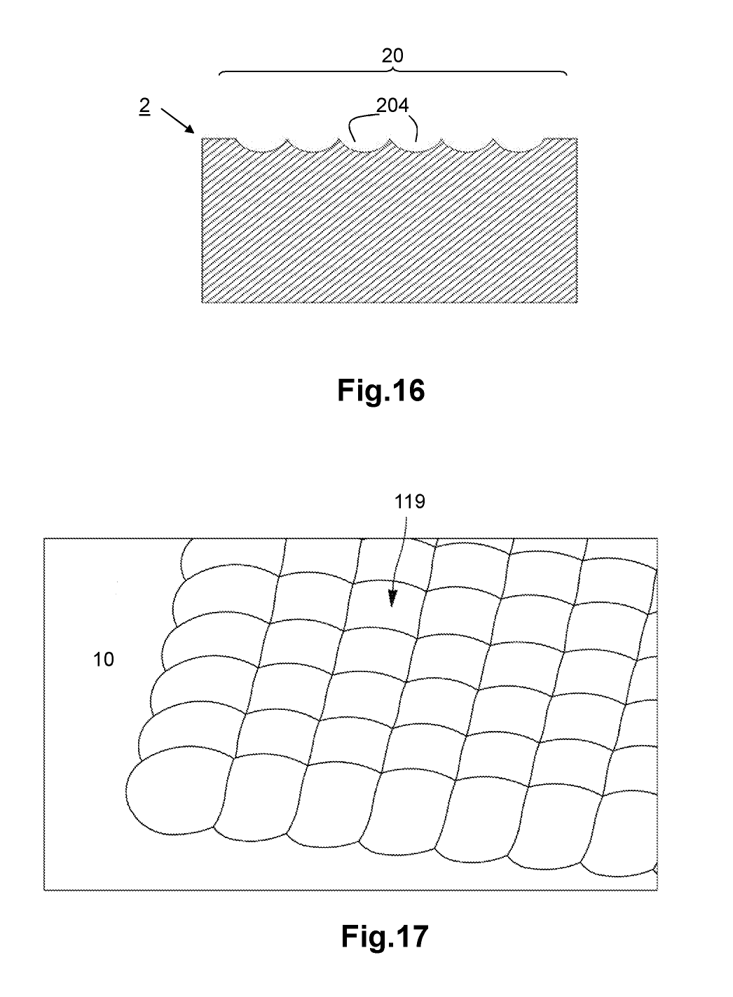

In a third embodiment illustrated in FIG. 16, the marking 20 comprises a set of recesses 204 suited to moulding the light parts 51 of the coded matrix symbol 5 and the said recesses 204 have the shape of concave caps of a sphere.

The recesses 204 make it possible to create a pattern that forms the light parts 51 which has boss elements 119 as illustrated in FIG. 17. The boss elements 119 all have the same shape. The shape is a closed surface. The shape is a cap of a sphere, also referred to as a shell or microlens. In the nonlimiting embodiment illustrated, the boss elements 119 are aligned with respect to one another. This makes it possible clearly to delimit the light parts 51. The geometric shape of the boss elements 119 is thus convex. Each cap of a sphere 119 is interpenetrated by several adjacent boss elements.

In a fourth nonlimiting embodiment (not illustrated), the marking 20 comprises a combination of second protruding elements 203 and of recesses 204 so as to create a combination of recessed elements 117 and boss elements 119.

Thus, the light parts 51 are made up of a pattern comprising:

a plurality of recessed elements 117; or

a plurality of boss elements 119; or

a combination of recessed elements 117 and of boss elements 119.

In other words, a light box 51 comprises a plurality of elements 117 and/or 119.

That makes it possible to make the parts 51 even lighter than the smooth surface of the sidewall 10.

The pattern is also formed as an integral part of the said sidewall 10. It is made of the same rubbery material as the sidewall of the tire. The elements 117 and 119 are therefore made of rubbery material.

Thus, by virtue of these second recessed elements 117/boss elements 119, the coded matrix symbol 5 comprises parts 51 which look lighter to somebody looking at the tire 1 than the dark parts 50 and can therefore easily be discerned with respect to these dark parts 50. That makes the reading/decoding of the coded matrix symbol 5 easier.

In order to obtain a manufacturing method that is easy to implement, in one nonlimiting embodiment, the density of recessed elements 117 and of boss elements 119 in the pattern is greater than or equal to 0.2 elements per mm².

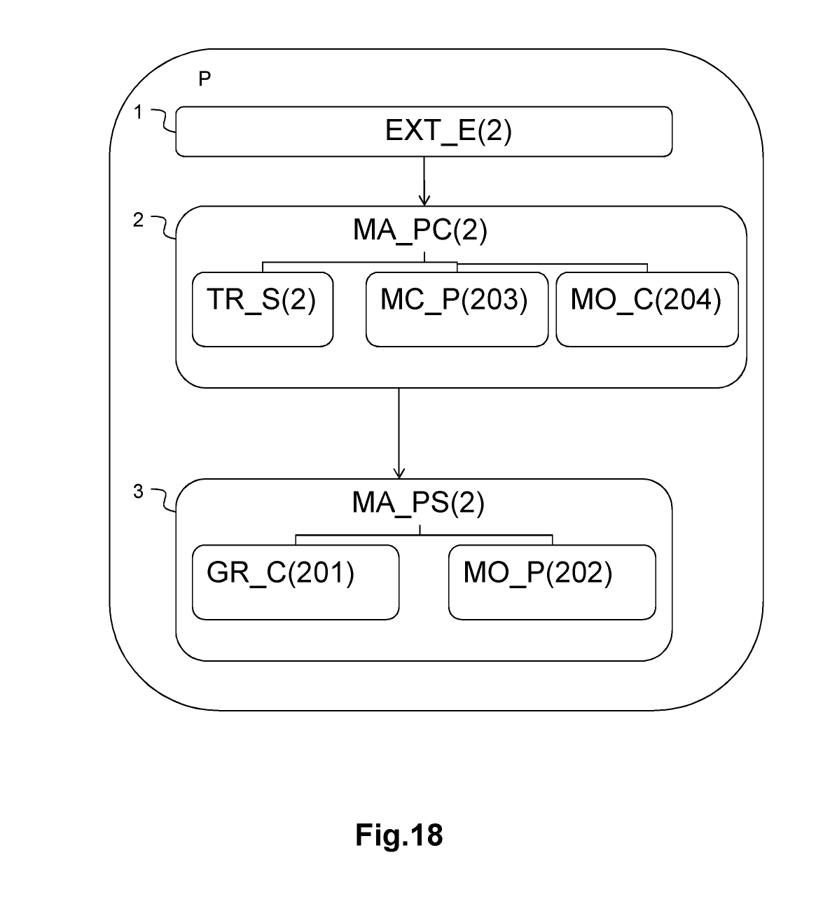

The method of manufacturing the mould element 2 for a mould 3 for a tire and the marking 20 thereof is described hereinbelow with reference to FIG. 18.

The said method P comprises:
extraction of the said mould element 2 from a sheet of aluminium (step 1 illustrated as EXT_E(2));
creation of the marking 20 intended to mould, on the tire 1, the coded matrix symbol 5 that contrasts with the sidewall 10 of the tire 1, the said coded matrix symbol 5 comprising dark parts 50 and light parts 51, the creation of the said marking 20 comprising:
   the creation of part of the marking 20 suited to moulding the light parts 51 of the coded matrix symbol 5 in the said mould element 2 (step 2 illustrated as MA_PC(2)); and
   the creation of part of the marking 20 suited to moulding the dark parts 50 of the coded matrix symbol 5 in the said mould element 2 (step 3 illustrated as MA_PS(2)).

It will be noted that one or more inserts 2 can be extracted from a sheet of aluminium simultaneously. Moreover, in some nonlimiting embodiments, extraction is performed using a pressing or trimming process.

In a first nonlimiting embodiment, the creation of the negative of the light parts 51 (step 2) and the creation of the negative of the dark parts 50 (step 3) are performed sequentially. Thus, the negative (namely the second protruding elements 203 or the set of recesses 204 seen hereinabove) of the light parts 51 is created first of all, followed by the negative (namely the first set of cavities 201 or of protuberances 202 seen hereinabove) of the dark parts 50. The light boxes 51 are thus created before the dark boxes 50.

In a first nonlimiting alternative form of embodiment, the creation of the marking suited to moulding the light parts 51 of the coded matrix symbol 5 in the said mould element 2 is performed after the extraction of the said mould element 2 from a sheet of aluminium.

In a second nonlimiting alternative form of embodiment, the creation of the marking suited to moulding the light parts 51 of the coded matrix symbol 5 in the said mould element 2 is performed before the extraction of the said mould element 2 from a sheet of aluminium. Creation is thus more rapid.

In a second nonlimiting embodiment, the steps of creating the parts of the marking 20 suited to moulding the light parts 51 (step 2) and the dark parts 50 (step 3) of the coded matrix symbol 5 in the said mould element 2 are performed simultaneously by pressing of the said mould element 2.

That makes it possible to obtain an inexpensive way of mass-production manufacture of coded matrix symbols.

The creation of part of the marking 20 suited to moulding the light parts 51 of the coded matrix symbol 5 (step 2) is carried out:
by a surface treatment of the said mould element 2 so that the surface of the said mould element 2 corresponds to the said light parts 51 (operation illustrated as TR_S(2)); or
by micro shot peening of the second set of protuberances 203 projecting from the said mould element 2 to form the marking 20 of the coded matrix symbol 5 so that the said protuberances 203 have the shape of caps of a sphere, each protruding element 203 being interpenetrated in the marking 20 by several adjacent protruding elements, the second set of protuberances 203 being suited to moulding the said light parts 51 of the coded matrix symbol 5 (operation illustrated as MC_P (203)); or
by moulding of the set of recesses 204 in the said mould element 2 in such a way that the said recesses 204 have the shape of caps of a sphere and are suited to moulding the said light parts 51 of the coded matrix symbol 5 (operation illustrated as MO_C (204)).

The surface treatment is performed in such a way that the arithmetic mean deviation parameter Ra indicative of the surface roughness of the mould element 2 is very low and less than 30 μm. The mould element 2 thus has a smooth reflective surface which evens out the mean light intensity reflected. The light parts 51 will thus have a surface roughness of parameter Ra less than 30 μm. The quantity of light reflected is thus maximized.

In one nonlimiting embodiment, the micro shot peening creates microbeads of a diameter comprised between 10 μm and 200 μm. In a nonlimiting alternative form of embodiment, the diameter is 50 μm.

Moreover, the creation of the part of the marking 20 suited to moulding the dark parts 50 of the coded matrix symbol 5 in the said mould element 2 (step 3) is performed by creating a first set of cavities 201 or of protuberances 202 in the said mould element 2 to correspond to the dark parts 50 of the coded matrix symbol 5, the creation of the first set of cavities 201 in the said mould element 2 being carried out by laser etching (operation illustrated as GR_C(201)) and the creation of the first set of protuberances 202 in the said mould element 2 being performed by moulding (operation illustrated as MO_P(202)).

The invention is not restricted to the examples described and depicted and various modifications can be made thereto without departing from its scope.

Thus, the invention has been described in conjunction with a marking 20. However, in another nonlimiting exemplary embodiment, the mould element 2 may comprise several markings 20 so as to create several coded matrix symbols 5 on the sidewall 10 of the tire 10.

Thus, according to another nonlimiting embodiment, the micro shot peening operation may be replaced by an operation of plastic deformation in order to form microlenses, for example using pressing, knurling, upsetting, etc.

Thus, according to another nonlimiting embodiment, the operation of etching the dark boxes 51 may be performed not with a laser but by mechanical machining or by punching (plastic deformation).

The invention described notably offers the following advantages:
the manufacture of the coded matrix symbol 5 can be incorporated into the manufacture of the tire 1 using an integrated mould, rather than being performed after the tire has been manufactured. Production is thus simplified and costs reduced;
that makes it possible to create a composition of the coded matrix symbol 4 with a texture of “velour” type formed as an integral part of the sidewall of the tire in the case of the dark parts 50 and with second recessed/boss elements in the case of the light parts 51.

1. A mould element for a mould for a tire comprising a marking, the mould comprising a shell adapted to mould the sidewall of the tire, said mould element being a removable insert adapted to be mounted in a housing of said shell, and said marking being adapted to mould on the tire a coded matrix symbol that contrasts with the sidewall of the tire, said marking comprising a first set of cavities or of protuberances which is configured to mould dark parts of the coded matrix symbol.

2. The mould element according to claim 1, wherein the marking comprises a second set of protuberances projecting from said mould element and configured to mould light parts of the coded matrix symbol and wherein said protuberances have the shape of caps of a sphere, each protruding element being interpenetrated by several adjacent protruding elements.

3. The mould element according to claim 1, wherein the marking comprises a set of set-back recesses configured to mould light parts of the coded matrix symbol and wherein said set-back recesses have the shape of caps of a sphere.

4. The mould element according to claim 1, wherein said mould element comprises a second set of cavities which is configured to mould a demarcation zone delineating the coded matrix symbol.

5. The mould element according to claim 1, wherein the cavities of the first set of cavities have a conical shape and are distributed through the marking at a density at least equal to one cone per square millimetre (mm²), each cone having a mean cross section comprised between 0.0005 mm² and 1 mm².

6. The mould element according to claim 1, wherein the cavities of the first set of cavities have a form of substantially mutually parallel striations, the spacing of the striations being at most equal to 0.5 mm, each striation having a mean width comprised between 0.02 mm and 0.25 mm.

7. The mould element according to claim 1, wherein the cavities of the first set of cavities have a parallelepiped shape of a side length comprised between 0.05 mm and 0.5 mm, of a depth comprised between 0.05 mm and 0.5 mm, the distance between two adjacent cavities in the marking being comprised between 0.05 mm and 0.5 mm.

8. The mould element according to claim 1, wherein the protuberances of the first set of protuberances have a conical shape and are distributed through the marking at a density at least equal to one protuberance per square millimetre (mm²), these protuberances having equivalent diameters comprised between 0.01 mm and 1.2 mm.

9. A mould for a tire comprising a shell adapted to mould the sidewall of the tire, wherein the shell comprises a housing in which is mounted a mould element according to claim 1.

10. A method of manufacturing a mould element for a mould for a tire, the mould comprising a shell adapted to mould the sidewall of the tire, said mould element being a removable insert adapted to be mounted in a housing of said shell and comprising a marking, wherein the method comprises:
extraction of said mould element from a sheet of aluminium;
creation of the marking adapted to mould, on the tire, a coded matrix symbol that contrasts with the sidewall of the tire, said coded matrix symbol comprising dark parts and light parts, the creation of said marking comprising:
creation of the marking suited to moulding the light parts of the coded matrix symbol in said mould element; and
creation of the marking suited to moulding the dark parts of the coded matrix symbol in said mould element.

11. The method of manufacture according to claim 10, wherein the steps of creating the marking suited to moulding the light parts and the dark parts of the coded matrix symbol in said mould element are performed simultaneously by pressing said mould element.

12. The method of manufacture according to claim 10, wherein the creation of the marking suited to moulding the light parts of the coded matrix symbol in said mould element is performed before the extraction of said mould element from the sheet of aluminium.

13. The method of manufacture according to claim 10, wherein the creation of the marking suited to moulding the light parts of the coded matrix symbol is carried out:
by a surface treatment of said mould element so that the surface of said mould element corresponds to said light parts; or
by micro shot peening of the second set of protuberances projecting from said mould element to form the marking of the coded matrix symbol so that said protuberances have the shape of caps of a sphere, each said protruding element being interpenetrated in the marking by several adjacent protruding elements, the second set of protuberances being configured for moulding said light parts of the coded matrix symbol; or
by moulding of a set-back set of recesses having the shape of caps of a sphere, said set of recesses being configured for moulding said light parts of the coded matrix symbol.

14. The method of manufacture according to claim 13, wherein the micro shot peening creates microbeads of a diameter comprised between 10 μm and 200 μm.

15. The method of manufacture according to claim 10, wherein the creation of the marking configured for moulding the dark parts of the coded matrix symbol in said mould element is performed by creating a first set of cavities or of protuberances in said mould element configured for moulding said dark parts of the coded matrix symbol, the creation of the first set of cavities in said mould element being carried out by laser etching and the creation of the first set of protuberances in said mould element being performed by moulding.
